(19) United States
(12) Patent Application Publication
(10) Pub. No.: US 2004/0205619 A1
(43) Pub. Date: Oct. 14, 2004

(54) Method and system for chained format translation

(76) Inventors: Roger S. Twede, Meridian, ID (US); John C. Cannon, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/077,344

(22) Filed: Feb. 14, 2002

(51) Int. Cl. G06F 17/24

(52) U.S. Cl. 715/523; 715/513

(57) ABSTRACT

System and methods for chaining the translation of data file formats by linking programs that convert datafiles between formats. A user submits a request to a controller program to convert a datafile from one format into another. The controller accesses a registry database to determine what translation programs (“translators”) are available, and designs a translation process linking the individual translators to perform the conversion. The translation job is controlled by job specification commands, preferably provided to each translator as a URL in HTTP protocol, that instruct each translator to access its data from the prior link in the translation chain. Format conversion occurs as the translators communicate directly with each other, passing the data down the chain. The process is especially suited for converting datafiles in unsupported formats into supported formats for printing.

### FIELD OF THE INVENTION

The present invention relates to printers and translating, or converting, data file formats. In particular, the invention relates to a system and methods for chaining format translators in varying sequences to render a data file in a first format available into a desired format, allowing it to be printed or otherwise used.

### BACKGROUND OF THE INVENTION

Computer programs typically store data in unique file formats. In order to allow different programs to use access and utilize that data, the file must often be translated, or converted, into a format that the program will recognize. Many programs include embedded translation features allowing certain types of files to automatically be translated and accessed therein, or may utilize translators that are installed to expand the functionality of the program. For example, Microsoft Word version 2000 is able to open HTML, MSRTF, AnsiText, PCText, AnsiTextCR, Unicode, EncodedText and PctextCR format files utilizing embedded translators and by installing additional translators may access even further file formats. In order to print a data file as a document, a printer similarly requires the data file be supplied to it in a recognized format. Typically, this requires the use of printer driver software that can convey the data to the printer in Printer Control Language (PCL), such that the printer may process the page image data and print a document.

Translating a file from one format into another typically requires the user to find and access a suitable translation program, and input the data into that program to perform the translation. Where no specific translator is available to accomplish the desired translation, a user must locate and assemble a chain of translations to arrive at the desired end format. If the translators are available over a network, the end result of each translation must be stored on the user's computer, requiring a series of individual steps to be undertaken, and the network to be accessed multiple times. This ties up the bandwidth of the network connection, and can be very inconvenient for the user. U.S. Pat. No. 5,911,776, issued Jun. 15, 1999 to Guck, and incorporated herein by reference in its entirety, describes a system for storing a series of virtual files alongside a data file in a computer system. The virtual files each contain a command to translate the data file into a desired format and to then supply translated file to a requesting user. While this system allows for the reduction of computer memory that is needed to store multiple versions of the same file, it lacks the ability to utilize large numbers of translators that may be available over a network or the Internet and instead requires an internal database containing all of the available translators.

As it is used herein, the term “printer” signifies any device capable of providing printer function alone or, alternatively, any device providing printer function in combination with one or more other document processing functions, such as, for example, copying, scanning, or facsimile capabilities. As used herein, the term “translator” signifies any computer executable program capable of converting a datafile from one format into another, whether the translator is a separate software program that can be executed by any appropriate processor, is included within a larger program or software package, is a sole processor or a series of processors dedicated to the conversion function, or any other translator type known now, or in the future, to those skilled in the art.

Unfortunately, many printers are under utilized as users are unable to transmit a file to the printer for printing, if the file is in a format that the printer is not capable of printing. Similarly, many users may be unable to access data files in desired programs, due to the formatting problems. A system, including a printer, that provided for translating files to a preferred format while eliminating the need for storing intermediate translations while utilizing translators located at any point on a network or over the internet, would be desirable.

### SUMMARY OF THE INVENTION

The present invention includes methods and an apparatus system, including a printer, for linking programs that convert datafiles between formats. In the present invention, a user submits a request to a controller program to convert a datafile from one format into another. The controller accesses a registry database to determine what translation programs are available, and designs a translation process linking the individual translators to perform the conversion. The translation job is controlled by job specification commands, preferably provided to each translator as a URL in HTTP protocol, that instruct each translator to access its data from the prior link in the translation chain. Format conversion occurs as the translators communicate directly with each other, passing the data down the chain. The process is especially suited for converting datafiles in unsupported formats into supported formats for printing.

### DESCRIPTION OF THE DRAWINGS

FIG. 1 is a block diagram of a printer which may be used in the methods and system of the present invention;

FIG. 2 illustrates a system of network components that may be advantageously used in the methods and system of the present invention; and

FIG. 3 is a diagram used to explain one possible method of converting file formats in some embodiments of the present invention.

### DETAILED DESCRIPTION OF THE INVENTION

The present invention provides methods and an apparatus system for chaining translation in order to convert data files into desired formats. These methods and apparatus system are especially useful in transforming file formats to allow the files to be printed as documents, with printer drivers that do not support printing those formats

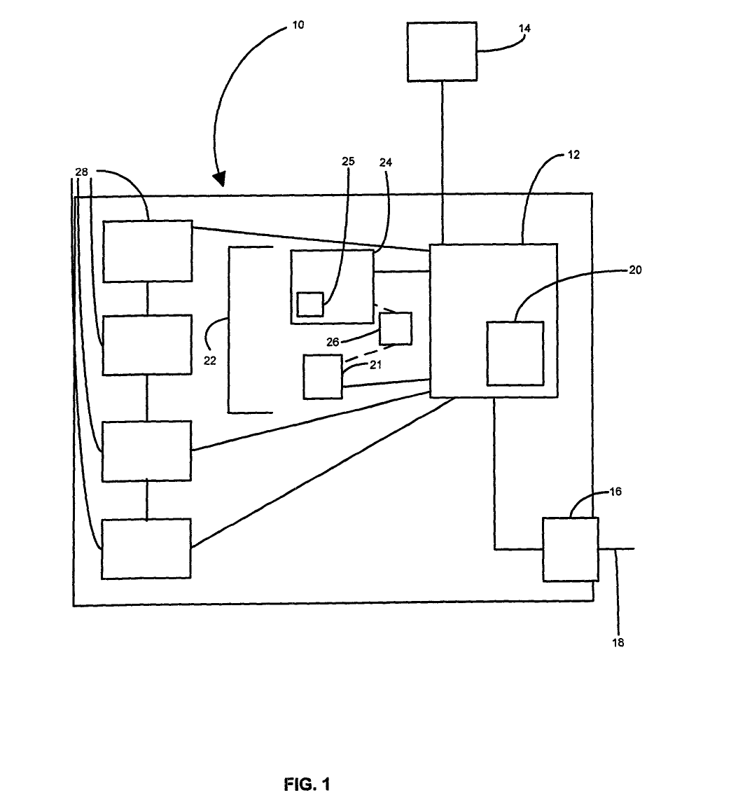

Referring to drawing FIG. 1, one possible embodiment of a preferred printer 10 for use in a system carrying out the methods of the present invention is shown. Printer 10 is configured with both printer specific hardware and software. Preferably, printer 10 includes an embedded Web interfacing system (e.g., a Web server 12) for enabling access and interaction with other devices linked to local and external communication networks (“networks”), including the World Wide Web (the “Internet”), a local area network (LAN), a wide area network (WAN), an intranet, the computer network of an online service, etc. It will be appreciated that the methods of the present invention may be carried out using a conventional printer that is in operative communication with a separate web server that is appropriately configured. The printer specific hardware and software of printer 10 may be provided in any conventional printer configuration known in the art, including those associated with laser printers, impact printers, photographic printers, and inkjet printers. Printer 10 includes a network interface (I/O) 16 for bidirectional data communication through one or more and preferably all of the various networks (LAN, WAN, Internet, etc.) using communication paths or links known in the art, including wireless connections, ethernet, bus line, Fibre Channel, ATM, standard serial connections, and the like.

When present, Web server 12 preferably provides one or more Web server functions to requesting users linked by way of one or more of the various networks (LAN, WAN, Internet, etc.). Such embodiments may thus be conceptually similar to the printer apparatus configured with an embedded Web server described in U.S. Pat. No. 5,956,487 to Venkatraman et al., assigned to the assignee of the present invention, the disclosure of which is incorporated by reference herein in its entirety.

Still referring to drawing FIG. 1, printer 10 includes at least one single microprocessor board (not shown), which includes a microprocessor 20. Microprocessor 20 is preferably part of the existing circuitry associated with a conventional printer. As such, microprocessor 20 is preferably configured to perform some or all of the printer specific functions of printer 10, including control of printer specific hardware and software.

Microprocessor 20 is provided with memory 22 in the form of RAM 21 and/or hard disk memory 24, which may be associated with the print cache of printer 10, or which may be provided separately from the print cache. As used herein, printer memory designated for temporarily or permanently storing one or more print jobs on hard disk memory 24 or other data storage device in printer 10 is referred to as “job retention” 25. In certain embodiments, a percentage of memory 22 in printer 10 may be dedicated to Web server 12. Alternatively, Web server 12 may share the available memory 22 in printer 10 with the print cache. A controller 26 is maintained in printer 10, preferably as a program with lines of executable code in memory 22, although it may instead be embedded. Controller 26 is configured as described below. Typically, printer 10 will be equipped with a minimum of 64 megabytes of RAM 21, although less or more RAM may be used in certain configurations as desired or required.

Microprocessor 20 is configured to follow the set of instructions, of controller 26, either embedded therein, or stored in memory 22 , to accomplish the translation of data file formats as described herein. Preferably, microprocessor 20 of printer 10 is further configured to translate coded language received from printer drivers of networked workstations into a bit-mapped image format (raster image format), and to store the translated print files in high capacity memory storage (i.e., job retention 25). Thus, the resulting “RIP'ed” (raster image processed) print jobs, representing graphical images of text or drawings along with associated print attributes, are stored in job retention 25 as “print ready files.”

In embodiments including a Web server 12, it is preferred that microprocessor 20 be responsible for controlling all the aspects of Web server 12. Thus, microprocessor 20 may be configured to process communication protocols and executable programs associated with Web server 12 which are stored in ROM (not shown) and/or hard disk memory 24. In one preferred embodiment, Web server 12 uses microprocessor 20 and the ROM-stored protocols to exchange data with other devices/users on one or more of the networks via Hyper Text Transfer Protocol (HTTP) and Simple Mail Transfer Protocol (SMTP), although other protocols such as File Transfer Protocol (FTP), Simple Network Management Protocol (SNMP), and Gopher document protocol may also be supported. Web server 12 may further be configured to send and receive HTML formatted files. In addition to being linked to a local area network (LAN) or wide area network (WAN), printer 10 may be linked directly to the Internet via network interface 16 and communication links 18 attached thereto.

Printer 10 will preferably contain executable software programs stored on hard disk 24 related to the operation of printer specific hardware. Hard disk 24 may also contain printer specific software programs relating to the operation of Web server 12, in those embodiments including a Web server 12. Alternatively, a separate hard disk (not shown) may optionally be provided with the requisite software programs for printing.

Mechanical components 28 of printer 10 are the mechanisms which are used to handle paper, to print documents, to assemble documents or to provide other additional functional characteristics to the printer 10. Mechanical components 28 may include the paper feeding mechanism, the inkjets of an inkjet printer, the laser scanning assembly and revolving drum and other associated mechanisms of a laser printer, other printing mechanisms known to those skilled in the art (now or in the future), a document collator, a document binder, a stapler, or any other mechanical component that may be included in a printer 10 to increase its functionality. Printer 10 may further include one or more displays 14 on which printer error or event messages may be displayed, or through which the web server 12 may be accessed by a user.

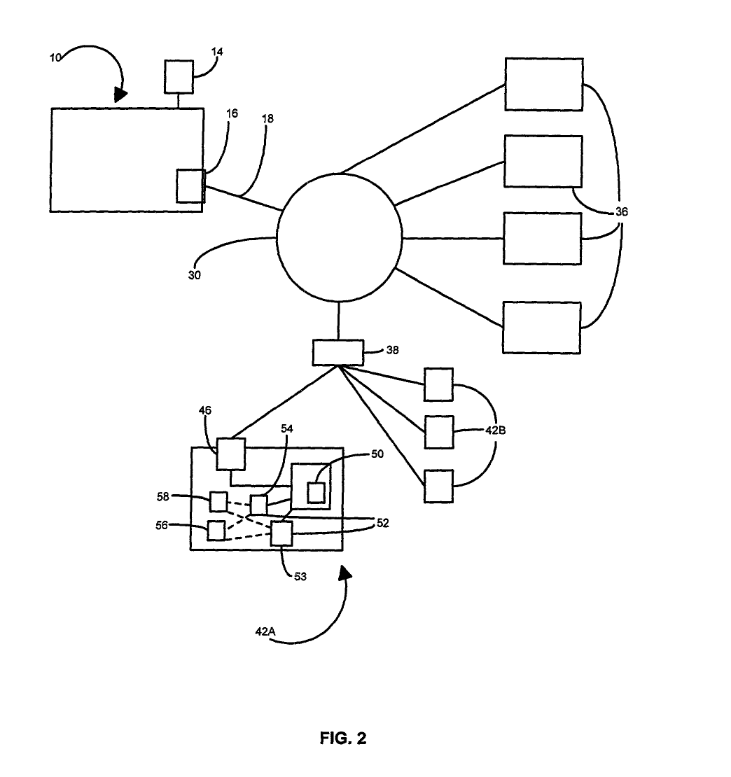

Referring now to drawing FIG. 2, printer 10 is shown as connected to a local computer network 30 to which are connected a number of computer workstations 36. Printer 10 is able to accept print jobs from each workstation 36 through network operative connections as known to those skilled in the art. Local network architecture 30 also includes a gateway 38, which will typically comprise a software and/or hardware firewall. Gateway 38 functions to block various external data transmissions from being sent to locations residing inside local network architecture 30. Gateway 38 also provides a port for outgoing Internet traffic. Gateway 38 is further preferably configured to internally route IP-Packets sent from workstations 36 to other web-based devices (e.g., printer 10) also residing within local network architecture 30, and vice versa.

An external computer 42A includes an I/O interface 46 that allows connections to be made to a computer network, including an Internet or other connection, similar to network interface 36 discussed above. External computers 42B represent other computers, or web enabled devices that may be accessed through operative connections to a computer network including the Internet. External computer 42A includes a microprocessor 50 which is provided with a memory 52. Memory 52 preferably includes RAM 53 and hard disk 54. Memory 52 may also include any other data storage devices or systems which are useful in practicing the present invention. A translator 58 is maintained in the memory 52, and may be available for download or may be implemented on the external computer 42, allowing microprocessor 50 to follow the instructions thereof and transform a data file from one format into another. A number of translators 58 may be maintained in the external computer 42, or in a number of external computers 42 that are available over the network, yet located at different geographic locations. For example, where the network includes the internet, the external computers 42 may be located anywhere in the world. Registry 56 is maintained in memory 52, preferably in hard disk 54, and contains a listing of the available translators 58 and their characteristics and locations. It will be appreciated that the registry 56 may be updated and revised as additional translators 58 become available and as the IP addresses where translators may be utilized are changed or are terminated. Access to the registry 56 may be offered on a subscription basis as one method of funding the implementation of the present invention. It will be further appreciated that embodiments of the present invention where the registry 56 is located at another location, such as within the memory 22 of the printer 10 or within the memory of a computer workstation 36 may also be designed by those skilled in the art. Preferably, external computer 42A functions as a web server that may communicate with printer 10 by conveying messages over network 30 via gateway 38.

Making reference to drawing FIGS. 1 and 2, one possible embodiment of a system for chaining translation of data file formats will now be discussed. It will be appreciated that the examples used and methods discussed are illustrative only and do not limit the present invention.

In a typical printing process over a network environment, such as network 30, a user at a computer workstation 36 typically uses print driver software to load documents or images into a buffer (usually an area on a disk of a workstation 36), where a printer 10 pulls them off the buffer at its own rate. The print driver functions to convert the text, graphics and print attributes specified by the data file on the user's workstation 36 into a set of codes that the printer 10 can translate and/or read. The set of codes is typically a form of a of Page Description Language (PDL). The PDL most commonly used as the printer coding language is Printer Command Language (PCL) developed by Hewlett-Packard for its dot-matrix, inkjet, and LaserJet series printers. Once the text, graphics and print attributes have been converted to a PDL, the PDL is transmitted by the workstation 36 over the network 30 where it is received by the printer 10 as a “print job.” Other examples of PDL's include Hewlett Packard's HP-GL/2 language and Adobe's PostScript®. A problem arises when the data file is in a format that the printer driver does not translate.

As the printer 10 receives the coded language from the print driver, it stores the information in high capacity memory storage (job retention 25), which typically comprises random-access memory (RAM 21) or hard disk 24. A stored print job thus comprises of one or more electronically stored files and the print attributes associated therewith. Before a typical print job (e.g., a PDL file) can be printed, however, its contents must be converted to a bit-mapped image format, also known as a raster image. The raster image is a bit-mapped representation of the document to be printed, with each bit in the bitmap representing the absence or presence of a dot (or pixel) on the printed page. A raster image processor (“RIP”) in the printer 10 typically translates PDL files to a raster image, also called a “RIP'ed” version of the file. Thus, the print files include data representing graphical images and the RIP'ed version is generated from the print file. Typically, print jobs are RIP'ed before storage in job retention 25, making them “print ready files.” In some cases, print jobs are received by the printer 10 in the form of raster image data. In that case, a processor 20 in the printer 10 may engage in pixel image manipulation when storing the print job. The printer 10 then uses the data in the print ready file to control the mechanical printing components 28 and the printing steps, such as paper feeding, controlling the inkjets of an inkjet printer or the laser scanning assembly and revolving drum and other associated mechanism of a laser printer.

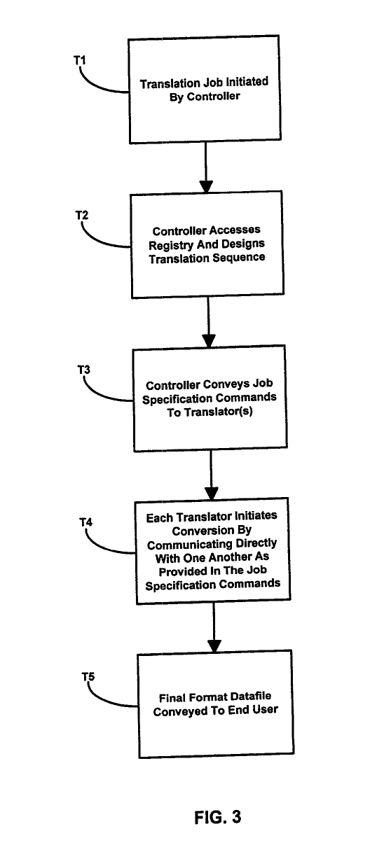

As discussed above, the text, graphics and print attributes specified by the user's workstation 36 must be converted into a set of codes that the printer 10 can translate and/or read. When the data file is in a format that the printer driver is incapable of converting to an appropriate PCL, the data file must first be converted into an appropriate format, in order for printing to occur. Turning to drawing FIG. 3, one possible process of chaining the translation of data files, in accordance with the principles of the present invention, is disclosed. This process will be discussed with respect to the embodiments of drawing FIGS. 1 and 2, but it will be appreciated that any suitable system may be used and that all such usages are within the scope of the present invention. In order to facilitate understanding of the translation chaining process, the data files formats of a translation job will be referred to in the following manner. The beginning format of the data file will be referred to as the initial format. The format that the data file will be converted to at the end of the process will be referred to as the final format. Intermediate formats that are utilized between the two will be referred to as formats A, B, C . . . and so forth.

As shown in box T1, a translation job is initiated by the controller 26. This may be accomplished in any of a number of ways. For example, a printer driver on a workstation 36 may lack the capacity to detail a data file format in PCL (in such an embodiment the final format will be PCL). The driver is configured to automatically activate the controller 26. The data file may be conveyed to the printer, or the controller 26 may be configured to access the data file at its existing location. Similarly, a program running on the webserver 12, or on a work station 36, may be configured such that an attempt to access a data file having an unsupported format automatically activates the controller 26 to initiate the translation job. This activation may be a command carried out inside the printer 10, or it may be conveyed to the printer 10 over the network 30 and network interface 16 and the communication link 18. Alternatively, a user at a workstation 36 may enter a command into the workstation causing the controller 26 to initiate a translation job. In yet another embodiment, in accordance with the principles of the present invention, the printer 10 may be configured to automatically initiate a translation job when a data file in an unsupported format is conveyed to it for printing. Other processes for initiating a job on a computer are known to those skilled in the art and all such processes, known now or in the future, maybe used and are within the scope of the present invention.

Once the translation job has been initiated, the controller 26 accesses the registry 56 to design a translation sequence utilizing the translators 58 known to be available for the initial file format and the final file format, as shown in box T2. One way in which this may be accomplished is by examining the information on available translators 58 in the registry 56 to determine what translators 58 are available with respect to the initial format and the final format. Should one or more translators 58 be available that are capable of directly converting the file from initial format to final format in a single step, such a single step translator will be selected.

If no translator 58 is available that can perform the conversion in a single step, then a chain of translators 58 must be designed and selected. This may be accomplished by generating a listing of all available translators 58 listed in the registry 56 that may be used to convert the data file in initial format into another format. If the final format is not on that list, the controller 26 then generates a similar listing for the formats that are available. This process continues until a chain of translators 58 is generated that may be used to convert the initial file format into the final file format. Such a chain may, for example, include converting initial format to format A, converting format A to format B, and then converting format B to final format. The chain may be as long or as short as is required.

It will be appreciated that it is within the scope of the present invention to include additional information on the available translators 58 and the potential chaining process in the registry 56 database. For example, multiple translators 58 may be available for converting a GIF image file into a JPG image file. The database may identify one such converter as producing the best results with respect to a color image, another with respect to a black and white image, and another with respect to presenting the image data to an additional translator 58. When converting a GIF data file to a JPG data file forms part of the chain generated in a translation job, the controller 26 may examine the registry 56 and select among the translators 58 available for this step to optimize the translation quality, the translation speed or any other aspect of the translation job.

Once the translation job is designed, the controller 26 activates the translation by supplying job specification commands to the translators 58. Each job specification command comprises a command received by a translator 58, providing the translator 58 with an IP address, or other location data from which to access the datafile in order to perform the conversion. The job specification command may also include other attributes associated with a conversion. For example, any change in the parameters of a file, such as the cropping or scaling of an image, may be contained in the job specification command. Translators 58 are “chained” to perform a series of conversions while communicating directly to each other through the job specification commands. This may be accomplished in several ways. Preferably the job specification commands utilize HTTP protocols, including those set forth by The Internet Society in The Hypertext Transfer Protocol—HTTP/1.1, RFC 2616, (1999) and HTTP Authentication: Basic and Digest Access Authentication RFC 2617, (1999), each of which is incorporated by reference herein in its entirety, as well as other versions of the HTTP protocols. It will be understood that any other protocol that may be used to supply job specification commands may be utilized in a process in accordance with the present invention, including SMTP, FTP or any other similar protocol. Each job specification command will specify a location from which the translator 58 may retrieve the data file to perform a format conversion. It is preferred that this location be specified using a uniform resource locator (URL).

The process of performing a translation job as a chain may be accomplished in a number of ways. For example, the job specification command provided to the last translator 58 in the chain, will identify the output of the prior translator 58 as the location from which the data file is to be read, job specification commands to intermediate translators 58 will similarly specify the output of the prior translator 58 as the location from which the data file is to be read, and the job specification command to the initial translator 58 will specify the location of the datafile in initial format. The job specification command thus contains “keys” to get access the datafile, also referred to as payload data, which is provided to a translator 58 to enable it to access the datafile from the immediately “upstream” translator 58, or other location. Separate job specification commands may be conveyed to each translator 58 in the chain. Alternatively, the job specification command supplied to the last translator 58 in the chain may be a “chain command,” that while specifying the location from which to obtain data may, as it requests that data from the prior translator 58, cause that prior translator 58 to similarly request the data from the location of its prior translator 58, and so forth, until the first translator 58, which is commanded to access the data file from an initial location.

In another possible embodiment, the job specification commands may instead specify the output location for each translator 58 in the chain. This may be accomplished by conveying the data file in initial format to the first translator 58, along with an additional command, either separate or encoded in the file by the controller 26, to convey the output to the next translator 58 in the chain. This continues to the final translator 58, which is commanded to convey the output to a final locale in final format. Alternatively, a number of separate job specification commands may be sent to each translator 58 in the chain, requiring each to convey their output to the next translator 58 in the chain. Other possible embodiments of structuring the job specification commands may also be designed and utilized within the process of the present invention, each providing that while the initial translator 58 in the chain accesses the data file in initial format at a first location, subsequent translators 58 will receive or access the data file directly from the preceding translator 58 in the chain. In this way, the memory 22 is not required to store intermediate format versions of the datafile, and the network 30, communications link 18 and network interface 16 need not be involved in each step of the translation job. The bandwidth capacity of the network and associated communications devices may thus be conserved as the datafile flows from one translator 58 to another without additional interaction with the originator of the translation job.

In response to the conveying of the job specification commands, each translator 58 in the chain initiates conversion by accessing data at the location provided by the job specification command. The datafile is converted into the final format via the chain of translators 58 as the data is passed directly from one translator 58 to another, as shown in box T4. In embodiments where a single job specification command is conveyed to the final translator 58 in the chain, which contacts the preceding translator 58 to access the file, causing an intermediate preceding translator 58 to similarly contact its preceding translator 58 to access the file, and the initial translator 58 to access the data file at its location. The data file is thus “pulled” through the chain of translators 58 to be converted into final file format by the final translator 58. In embodiments where separate job specification commands are used to instruct the final translator 58 and each intermediate translator 58 in the chain to access the data file from the preceding translator 58, and to instruct the initial translator 58 to directly access the datafile in initial format, translation similarly occurs as each subsequent translator 58 accesses the output of the preceding translator 58 to perform the format conversion.

In alternative embodiments where the job specification command (or each of multiple job specification commands) includes instructions to the translator 58 to direct the converted datafile to a specific location, the initial and each subsequent translator 58 conveys its converted datafile output to the subsequent translator 58 in the translation chain, “pushing” the datafile through the conversion process.

Once the final translator 58 in the translation chain has converted the datafile into the final format, the converted datafile is then conveyed to a final user of the converted file, as shown in box T5. The final user may be a user at a workstation 36 requesting the conversion, a program running on a workstation 36 or server that requires the conversion to utilize the datafile, a raster image processor in a printer 10 which required the conversion in order to print the datafile, or any other suitable final user. The conveyance may occur in any suitable manner, for example in embodiments where the data to be converted is received at each translator 58 along with a command specifying a location for the output to be conveyed to, the job specification command received by the final translator 58 includes the location to which the datafile is to be conveyed. Similarly, the job specification commands conveyed to the translators 58 in other possible embodiments may specify the final conveyance location. Alternatively, the controller 26 may utilize an additional program or protocol to convey the datafile in final format from the default output location of the final translator 58.

The converted datafile in final format may be conveyed to the final user using any suitable communications protocol or process. Examples include SMTP, HTTP, FTP although it will be appreciated that any other suitable protocol may be used.

It will be appreciated that the variations and additional embodiments of processes for linking translator 58 programs accessible over a network (which may include the internet), or even within a single device, are possible to carry out differing embodiments of the present invention. All such embodiments are within the scope of the present invention.

Accordingly, the present invention includes a method of converting a datafile into an appropriate final format for printing, comprising the acts of conveying the datafile in an initial format to a printer that is configured to receive datafiles in a number of initial formats and to print datafiles from an appropriate final format. The printer will comprise a controller that is activated to initiate the translation of the datafile into an appropriate final format. A registry database containing information on translators is then accessed with the controller to determine the availability of a selection of translators over a network. Translators are then selected from the selection of translators to design a conversion sequence that includes an initial translator and one or more subsequent translators. One or more job specification commands are then conveyed to at least one of the translators to initiate the conversion sequence, such that the initial translator in the sequence accesses said datafile in said initial format and each of the subsequent translators in the conversion sequence directly accesses the output of the prior translator in the sequence. The datafile is converted to an appropriate final format as the initial translator in said conversion sequence accesses the initial format datafile and converts it into output in another format, and each of the subsequent translators in the sequence directly accesses the output of the prior translator and converts it into a subsequent format until the datafile is converted into the appropriate final format. The datafile in appropriate final format is conveyed to the printer; and then printed from the appropriate final format.

It is preferred that the printer include a web server that may be used as a web client to convey the job specification command or commands and to access the registry (where the registry is contained on a separate computer accessible over the network) in response to user inputs. The job specification command preferably includes at least one URL. In embodiments where the data is “pulled” through the conversion sequence, it is preferred to convey a single job specification command to the final translator in the sequence, and to access the data from the prior translator in the sequence. In embodiments where the data is “pushed” through the conversion sequence, it is preferred to convey a single job specification command to the initial translator in the sequence, and to directly convey the output data to the next translator in the sequence. The translators may be located on computers that are geographically remote and accessible over a network, including the internet.

The present invention further includes a method of linking format conversion programs to convert a datafile from an initial format into a desired final format, comprising a number of acts. This method may be practiced by accessing a registry database containing information on translators to determine what translators are available over a network and then selecting among those translators to design a conversion sequence including an initial translator and one or more subsequent translators. Next one or more job specification commands are conveyed to one or more translators in the conversion sequence to activate to initiate the conversion sequence, causing the initial translator in the conversion sequence to access the datafile in the initial format and the subsequent translators to directly access the output of the prior translator in the sequence. The datafile is then converted to the desired final format as the initial translator in the initial format datafile and converts it into output in another format, and each of the subsequent translator directly accesses the output of the prior translator in the conversion sequence and converts it into a subsequent format until the datafile is converted into the desired final format.

It is preferred that the job specification command preferably include at least one URL. In embodiments where the data is “pulled” through the conversion sequence, it is preferred to convey a single job specification command to the final translator in the sequence, and to access the data from the prior translator in the sequence. In embodiments where the data is “pushed” through the conversion sequence, it is preferred to convey a single job specification command to the initial translator in the sequence, and to directly convey the output data to the next translator in the sequence. The translators may be located on computers that are geographically remote and accessible over a network, including the internet. It is further preferred that the registry database be located at a remote location accessible over the network, or the internet, and that it be periodically updated.

It will be appreciated by those skilled in the art that illustrated embodiments herein described are not intended to limit the invention or the scope of the appended claims. Various combinations and modifications of the preferred embodiments could be made without departing from the scope of the present invention and all such modification are within the scope of the present invention. For example, it is understood that while the methods and apparatus of the present invention have been described in relation to a workstation interacting with a printer, one of skill in the art will recognize that the present invention may be utilized with a wide variety of networked and/or Web-based devices.

Thus, while certain representative embodiments and details have been shown for purposes of illustrating the invention, it will be apparent to those skilled in the art that various changes in the invention disclosed herein may be made without departing from the scope of the invention, which is defined in the appended claims.

What is claimed is:

1. A method of converting a datafile having a first format into a second format for printing, comprising:
conveying the datafile in a first format to a printer, said printer for receiving datafiles in a first format and printing datafiles from a second format, said printer including a controller,
activating said controller for translating said datafile into said second format;
accessing a registry database over a network using said controller for selecting a translator;
selecting a translator for a conversion sequence, said conversion sequence including an initial translator and at least one subsequent translator;
conveying at least a first job specification command to at least one translator in said conversion sequence, said initial translator in the sequence accesses said datafile in said first format and said at least one subsequent translator in said conversion sequence directly accessing an output of said initial translator;
converting said datafile to said second format;
conveying said datafile in said second format to said printer; and
printing said datafile from said second format.

2. The method of claim 1, where said printer further comprises a web server.

3. The method of claim 2, wherein said at least a first job specification command is conveyed using said web server.

4. The method of claim 1, wherein said at least first job specification command comprises a uniform resource locator (URL).

5. The method of claim 1, wherein said at least first job specification command is conveyed to a last of said subsequent translators in said conversion sequence.

6. The method of claim 5, wherein said at least a first job specification command activates said last subsequent translator to access data directly from said prior translator in said conversion sequence.

7. The method of claim 1, wherein said at least first job specification command is conveyed to said initial translator.

8. The method of claim 7, wherein said at least first job specification command activates said initial translator to directly convey output data to said at least one subsequent translator.

9. The method of claim 1, wherein said registry database is contained on a computer that is geographically separate from said printer, and accessing said registry is accomplished over a network connection.

10. The method of claim 1, where said initial translator and said at least one subsequent translator are located on geographically separate computers that are accessible to one another and to said printer over a network.

11. The method of claim 10, wherein said network includes the internet.

12. A method of linking format conversion programs to convert a datafile from an initial format into a desired final format, comprising:
accessing a registry database containing information on translators to determine what translators are available over a network;
selecting among said translators to design a conversion sequence, said conversion sequence including an initial translator and at least one subsequent translator;
conveying at least a first job specification command to at least one translator in said conversion sequence to activate to initiate said conversion sequence, such that said initial translator in said conversion sequence accesses said datafile in said initial format and said at least one subsequent translator in said conversion sequence directly accesses an output of said initial translator;
converting said datafile to said desired final format as said initial translator in said conversion sequence accesses said initial format datafile and converts it into said output in another format, and each said subsequent translator in said conversion sequence directly accesses said output of said prior translator in said conversion sequence and converts it into a subsequent format until said datafile is converted into said desired final format.

13. The method of claim 12, wherein said at least first job specification command comprises a uniform resource locator (URL).

14. The method of claim 12, wherein said at least first job specification command is conveyed to a last of said subsequent translators in said conversion sequence.

15. The method of claim 14, wherein said at least a first job specification command activates said last subsequent translator to access data directly from said prior translator in said conversion sequence.

16. The method of claim 12 wherein said at least first job specification command is conveyed to said initial translator.

17. The method of claim 16, wherein said at least first job specification command activates said initial translator to directly convey output data to said at last one subsequent translator.

18. The method of claim 12, wherein said registry database is contained on a computer that is geographically separate from said printer, and accessing said registry is accomplished over a network connection.

19. The method of claim 12, where said initial translator and said at least one subsequent translator are located on geographically separate computers that are accessible to one another and to said printer over a network.

20. The method of claim 19 wherein said network includes the internet.

21. A system for printing a datafile in an unsupported initial format, comprising:
a registry database containing information concerning a selection of datafile format translators that are available using a network;
a printer attached to said network, said printer configured to receive datafiles in a number of unsupported initial formats and to print datafiles from an appropriate final format, said printer further comprising a controller,
said controller configured to initiate a translation of said datafile from said unsupported initial format into said appropriate final format by accessing said registry database to determine an availability of said selection of translators over said network and designing a conversion sequence from said selection including an initial translator and at least one subsequent translator to perform the conversion;
said printer further configured to convey at least a first job specification command to at least one translator in said conversion sequence to activate to initiate said conversion sequence, such that an initial translator in said conversion sequence accesses said datafile in said unsupported initial format and at least one subsequent translator in said conversion sequence directly accesses an output of said initial translator to convert said datafile in an unsupported into a subsequent format until said datafile is converted into said appropriate final format allowing the datafile to be printed.

22. The system of claim 21, wherein said registry database is stored on a computer in operative communication with said network.

23. The system of claim 22, wherein said network includes the internet.
